(19) United States
(12) Patent Application Publication
(10) Pub. No.: US 2016/0275574 A1
(43) Pub. Date: Sep. 22, 2016

(54) METHOD AND SYSTEM OF COMPUTING A RATING FOR A SERVICE PROVIDER

(71) Applicant: MasterCard Asia/Pacific Pte Ltd, Singapore (SG)

(72) Inventors: Sanket NERKAR, Nashik (IN); Mayank PRAKASH, Uttarakhand (IN); Amit SINGH, Lucknow (IN)

(21) Appl. No.: 15/074,889

(22) Filed: Mar. 18, 2016

(30) Foreign Application Priority Data
Mar. 20, 2015 (SG) 10201502195U

(51) Int. Cl. G06Q 30/02; G06Q 50/00

(52) U.S. Cl. CPC G06Q 30/0282; G06Q 50/01

(57) ABSTRACT

A computer-implemented method for computing a rating for a service provider is provided. Thee method comprising operations of (a) receiving, by a transaction analysis component, transaction data representing past transactions performed by customers with the service provider via a payment network, (b) calculating, by the transaction analysis component, a transaction-based measure characterizing the past transactions during a pre-defined period; (c) receiving, by a service provider rating component, a review score indicative of a customer rating for the service provider; and (d) computing, by the service provider rating component, the rating using the transaction-based measure and the review score, said rating being indicative of a quality of service associated with the service provider. A system for carrying out the method is also provided.

### RELATED APPLICATION

This application claims priority to Singapore Patent Application No. 10201502195U, entitled METHOD AND SYSTEM FOR COMPUTING A RATING FOR A SERVICE PROVIDER, filed Mar. 20, 2015 and is hereby incorporated by reference in its entirety.

### FIELD OF DISCLOSURE

The disclosure relates to a method and system of computing a rating for a service provider. In particular, it provides a method and system of generating a rating indicative of a quality of service associated with the service provider.

### BACKGROUND

Many customers or potential customers (i.e. human subjects) often consult other people's recommendations or reviews before making a decision to engage a service provider, especially for essential services such as healthcare. The recommendations or reviews could be a personal one such as those provided by a friend or a family member of the subject, or a non-personal one such as those provided by the general public. The public's rating on a service provider (such as reviews and recommendations by customers who had previously used the service provider) can be found on one or more social media such as online websites, news media, etc. Social media data such as online reviews give customers or potential customers quick access to information which helps them make informed decisions faster and more easily. The review data are typically indicative of a customer rating for the service provider. It has been shown that many potential customers trust review data from the social media, and as a result, the review data usually influence or even guide a potential customer's decision to use or select a service provider. For example, potential customers are more likely to engage a service provider with positive reviews or higher rating, which are, for example, indicative of a higher quality of service rendered.

However, reviews and recommendations from social media data are not always reliable since they may not be genuine. For example, the reviewers may give a false review or rating because they have a personal association with the service provider or have received financial incentives from the service provider. In this case, customers who rely on those reviews or rating may be misled by the false information.

### SUMMARY

The embodiments provide a reliable way of generating a rating for a service provider for guiding a customer or potential customer's decision of selecting the particular service provider. Typically, a rating can be generated for each of a plurality of service providers which provide a similar service. This allows the human subject to obtain information about a quality of the service provided by the service providers from their respective rating. For example, it will help a patient to identify the best doctor, hospital, or any other healthcare service provider in their neighbourhood.

In general terms, the embodiments propose using transaction level data describing transactions customers have had with a service provider in combination with review data indicative of a customer rating for the service provider.

According to a first aspect, there is provided a computer-implemented method for computing a rating for a service provider, the method comprising operations of:

(a) receiving, by a transaction analysis component, transaction data representing past transactions performed by customers with the service provider via a payment network,

(b) calculating, by the transaction analysis component, a transaction-based measure characterizing the past transactions during a pre-defined period;

(c) receiving, by a service provider rating component, a review score indicative of a customer rating for the service provider; and

(d) computing, by the service provider rating component, the rating using the transaction-based measure and the review score, said rating being indicative of a quality of service associated with the service provider.

The use of transactional level data in computing the rating allows a more reliable rating to be generated since it allows the review data/score to be substantiated and/or verified by the transactional level data. In other words, review data/score which is unsubstantiated by or contradicts the transactional level data will be given less weight or be disregarded when computing the rating. On the other hand, review data/score which are consistent with the transactional level data may carry more weight towards the rating. Therefore, the rating can be a robust and reliable indicator of the quality of the service provider. Generally, a higher rating is indicative of a better quality of service. A rating is typically, but not necessarily represented by a numerical value (e.g. rating: 8 out of 10), or an alphabetical or alphanumeric value (e.g. rating: A).

In one embodiment, the transaction-based measure represents a number of the past transactions during the pre-defined period. This allows the traffic at the service provider to be identified quantitatively, which may serve an important indicator of the popularity of the service provider as well as its quality. For example, the transaction-based measure takes a higher numerical value if the number of past transactions with a given service provider is higher. In another embodiment, the transaction-based measure represents a transaction amount of past transactions.

In one embodiment, the transaction data comprises information about payment devices associated with respective past transactions, such as a card number (e.g. a primary account number, PAN) or any other payment device identifier.

In one embodiment, the method further comprises:

the transaction analysis component determining, for each payment device, a number of all the past transactions associated with the payment device within the pre-defined period,

the transaction analysis component identifying one or more payment devices which are being associated with more than one past transactions; and

the service provider rating component calculating the transaction-based measure using the one or more identified payment devices.

This allows repeated transactions or purchases using the same payment devices to be identified. Repeated transactions may be an indicator of loyalty of the customers, and may be indicative that the given service provider has been offering positive service to the customers. A transaction-based measure so generated takes into account repeated purchase behavior of the customers and is therefore a more robust support or proof of the quality of the service provider.

In one embodiment, the transaction analysis component generates, for each payment device, a weight factor based on the number of all the past transactions associated with the payment device; wherein the service provider rating component calculates the transaction-based measure using at least one of (i) the number and (ii) the corresponding weight factor, associated with each of the payment devices. For example, the weight factor for the payment device increases as the number increases. By assigning different weights to different transaction patterns (in this example, repeated purchases are assigned more weight compared to one-off purchases), the generated transaction-based measure may be an improved characterization of transactions attributable to the outstanding quality of the service provider instead of those random one-off transactions.

In one embodiment, the transaction-based measure represents a ratio of a number of the past transactions performed by the identified payment devices to a total number of the past transactions. In other words, the transaction-based measure reflects the proportion of recurring transactions among all transactions.

In one embodiment, the transaction-based measure represents a ratio of a number of the identified payment devices to a total number of the payment devices. In this case, the transaction-based measure may be representative of the proportion of loyal (e.g. re-visiting) customers among all customers.

In one embodiment, operation (d) comprises calculating a weighted sum of the transaction-based measure and the review score. For example, the transaction-based measure and the review score respectively carries a weight of 67% and 33% (i.e. a weight ratio of 2:1).

The review score and the transaction-based measure therefore may carry different weight when determining the rating. For example, for a review score which contradicts a traffic pattern observed from the transactional level data, the review score will carry little weight when computing the rating.

In one embodiment, the method further comprises:

the transaction analysis component receiving further transaction data representing past transactions performed by customer with a second service provider via a payment network, said further transaction data including information about payment devices associated with respective past transactions, the second service provider being a substitute to the service provider in respect of a range of services provided, the method further comprising:

identifying one or more payment devices which performed transactions with both service providers within a pre-defined time window;

determining a loyalty measure associated with the service provider using the identified transactions; and

calculating the transaction-based measure further using the loyalty measure.

This allows the transaction analysis component to identify a “switch” by a customer from one service provider to another for a similar range of services. In other words, if a customer, for example, a patient, is performing transactions with another doctor or hospital within a certain timespan from his transaction with a hospital he previously visited, this may indicate that the patient is not entirely satisfied with the service of the previously visited hospital.

In one embodiment, the method further comprises:

receiving, by a service provider analysis component, a similarity measure describing an extent of similarity in one or more characteristics of the two service providers, said characteristics comprising one or more of: (i) a geographic location of the service provider and (ii) an area of specialty in service; and

determining, by the service provider analysis component, the loyalty measure associated with the service provider further using the similarity measure.

For example, if the two service providers are determined to be providing services in the same specialty and in the same neighbourhood, then it is more likely that the “switch” by the customer is attributable mainly to the dissatisfaction with regards to the quality of the service provider.

In one embodiment, the two service providers are healthcare service providers (such as hospitals and/or doctors) and said characteristic comprises an area of specialty in medicine of the healthcare service providers.

In one embodiment, the review score is obtained using review data from one or more social media servers. Review data may include, for example, reviews by existing customers who have had performed one or more transactions with the service provider. Review data may also include reviews by a potential customer who has not yet performed any transaction with the service provider, and in this case, his/her rating of or opinion on the service provider may be based on a friend's or family member's recommendations on or prior experiences with the service provider.

In one embodiment, the review data is retrieved and aggregated from the servers and is categorized into a plurality of categories, for example, as positive, neutral or negative. The categorization may be performed using sentimental analysis. Each of the categories is assigned a respective review score representing a customer rating of the service provider.

According to a second aspect, there is provided a computer system having a processor and a data storage device, the data storage device storing instructions operative by the processor to cause the processor to perform a method as disclosed above.

The invention may further be expressed as a non-transitory computer-readable medium for computing a rating for a service provider, the computer-readable medium having stored thereon program instructions for causing at least one processor to perform a method as disclosed above.

The term healthcare service provider refers to any individual, institution or any other organization which offers preventive, curative, promotional or rehabilitative health care services. The healthcare service provider may have one or more professionals operate within one or more of medicine, surgery, midwifery (obstetrics), dentistry, nursing, pharmacy, psychology or allied health professions.

### BRIEF DESCRIPTION OF THE DRAWINGS

Embodiments of the invention will now be described for the sake of non-limiting example only, with reference to the following drawings in which:

FIG. 1 is a flow diagram of a method according to an embodiment of the invention;

FIG. 2 is a block diagram illustrating a system according to an embodiment;

FIG. 3a is a flow diagram of a sub-operation of an exemplary method;

FIG. 3b is a flow diagram of a sub-operation of another exemplary method; and

FIG. 4 is a flow diagram of a method according to a further embodiment, which is a variant of the method of FIG. 4.

### DETAILED DESCRIPTION

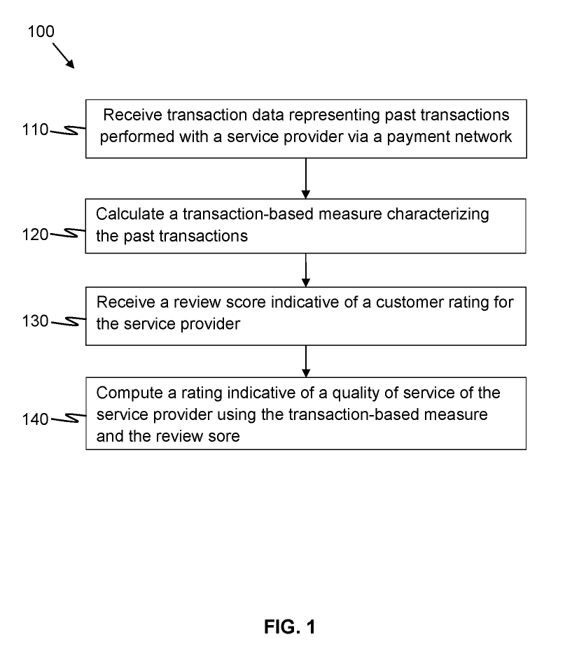

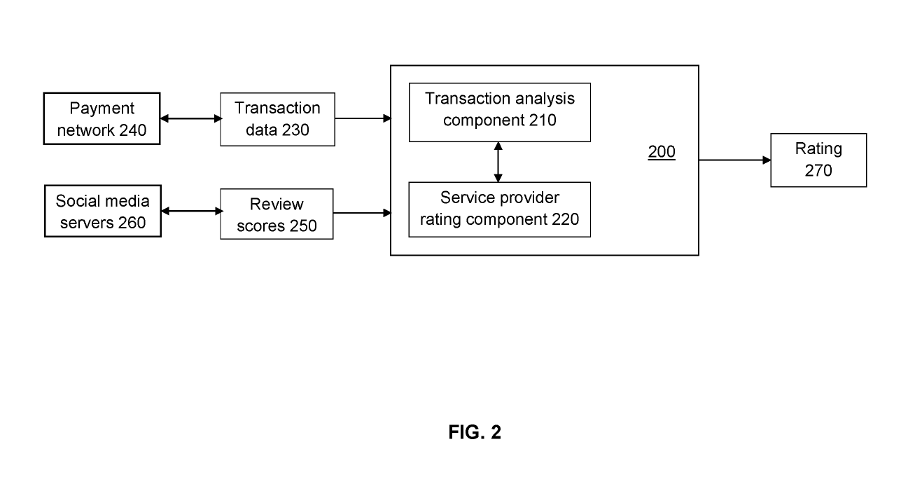

FIG. 1 shows an exemplary method 100 for computing a rating for a service provider using transactional level data. The rating is indicative of a quality of service provided or otherwise associated with the service provider, for example, a hospital. The block diagram of FIG. 2 illustrates a system 200 for carrying out the method 100. The embodiments below are illustrated with reference to healthcare service providers such as hospitals. It will be understood that the embodiment is not limited to hospitals or other healthcare service providers.

The system 200 comprises a transaction analysis component 210 in communication with a service provider rating component 220. The transaction analysis component 210 and the service provider rating component 220 may be implemented as or by one or more computer processors. The system 200 further has a data storage device (not shown) storing instructions operative by the one or more processors to cause the processor to perform the method 100. The data storage device may be any physical persistent storage device such as, but not limited to, harddrive and/or thumbdrive, or network storage such as a Network Attached Storage (NAS), Storage Area Network (SAN) or a cloud storage system.

At step 110, the transaction analysis component 210 receives transaction data 230 representing past transactions performed by customers with the hospital via a payment network 240. The payment network 240 may be any electronic payment network which connects, directly and/or indirectly payers (the customer and/or their banks or similar financial institutions) with payees (the hospital and/or their banks or similar financial institutions). Non-limiting examples of the payment network 240 are a payment card type of network such as the payment processing network operated by MasterCard, Inc., mobile telephone payment networks and the like (it should be noted that the primary purpose of the payment network may not be payment; for example, a mobile telephony network may offer payment network capability even though its primary purpose may be mobile telephony).

The transaction data 230 may comprise information about a payment device associated with each of the past transactions. The payment device is any suitable cashless payment device that can be used as a method of payment for performing a transaction. The payment device is typically a payment card such as such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. The information about the payment device may include a card number, account number and/or any other payment device identifier which allows the payment device to be uniquely identified.

The transaction data 230 can be received directly from the payment network 240 over a communication network, or from a database in communication with the system 200, e.g. a data warehouse which stores transaction data from the payment network.

The transaction data 230 may comprise further information such as acquirer identifier/card accepter identifier (the combination of which uniquely defines a merchant—the hospital or any other service provider, in this case); merchant category code (also known as card acceptor business code), that is, an indication of the type of business the merchant is involved in (for example, a healthcare service provider); cardholder base currency (i.e., U.S. Dollars, Euros, Yen, etc.); transaction time and date; location (full address and/or GPS data); transaction amount (also referred to herein as ticket size); terminal identifier (e.g., merchant terminal identifier or ATM identifier).

At step 120, the transaction analysis component 210 calculates a transaction-based measure describing the past transactions during a pre-defined period. For example, the transaction-based measure can be calculated based on a total number of the past transactions and/or total transaction amount carried out via the payment network 240 during the pre-defined period. Ideally, the transaction-based measure is indicative of the amount of traffic in or a proportion of transactions performed by patients with the hospital, which is mainly attributable to the good quality of the service rendered by the hospital. In other words, the transaction-based measure can be viewed as a quantitative indicator which reflects a quality of service rendered by the hospital.

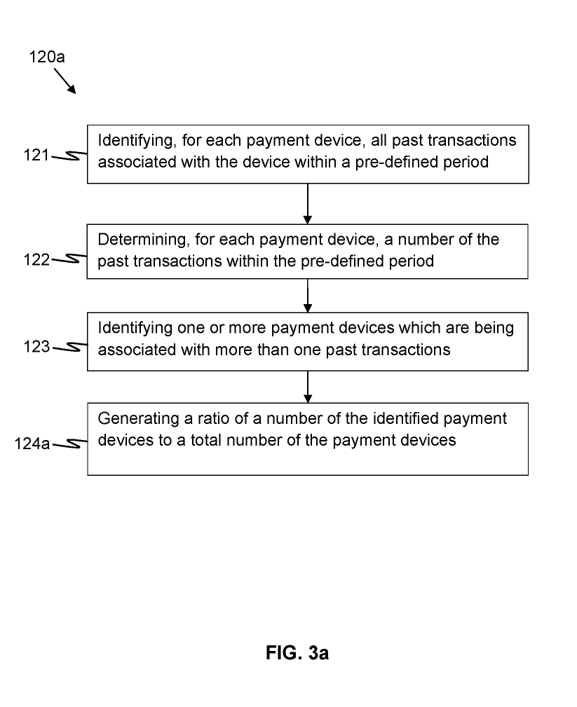

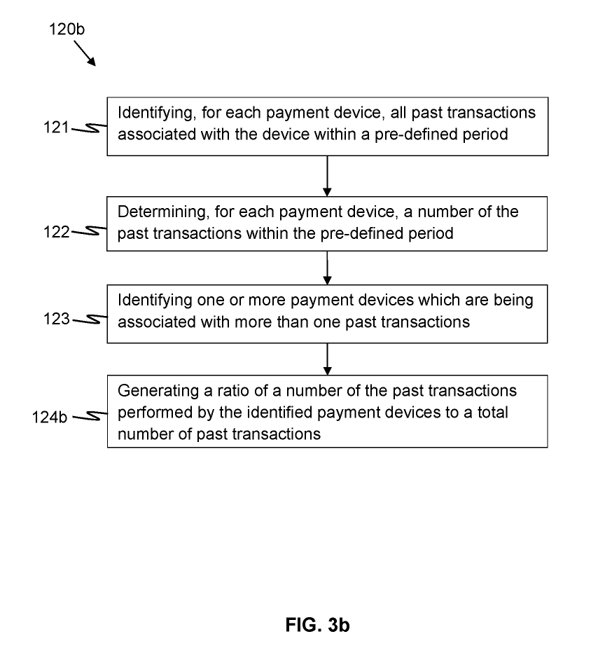

FIG. 3a shows an exemplary method 120a of calculating the transaction-based measure using the transactional level data. At sub-step 121, the transaction analysis component 210 identifies, for each payment device, all the past transactions associated with the payment device within a pre-defined period. At sub-step 122, the transaction analysis component 210 determines for each payment device, the total number of the past transactions within the pre-defined period. Payment device(s) which are being associated with more than one past transaction are then identified at sub-step 123 by the transaction analysis component 210 and at sub-step 124a, the transaction analysis component 210 computes a ratio representing the number of the identified payment devices to the total number of payment devices.

FIG. 3b shows another exemplary method 120b of calculating the transaction-based measure using the transactional level data. In this example, sub-steps 121-123 are the same while the last sub-step 124b generates a transaction-based measure which is a ratio of a number of the past transactions performed by the identified payment devices to a total number of past transactions (performed by all payment devices).

Other ways of generating the transaction-based measure are possible. For example, after determining the number of past transactions associated with each of the payment devices, a weight factor can be generated for each payment device based on the number of past transactions associated therewith. The weight factor and/or the number of transactions may be used for the calculation of the transaction-based measure. Since repeated transactions by the same patient or the same payment device are likely to be indicative of patient's satisfaction or preference with the service of the hospital, a higher weight could be given for those transactions when calculating the transaction-based measure so that transactions attributable to the quality of the service of the hospital is emphasized. On the other hand, those non-repeated, one-time off transactions may carry less weight since there are less certainty as to whether those transactions are due to patient's particular preference for service quality offered by the hospital. The transaction-based measure can be generated using either or both the weight factor and the number of transaction associated with each payment device for all the payment devices.

At step 130, the service provider rating component 220 receives a review score 250 indicative of a customer rating of the hospital. In one embodiment, the review score 250 is obtained using review data from one or more social media servers 260. Review data may include, for example, reviews by existing patients who have had performed one or more transactions with the hospital. Review data may also include reviews by a visitor or a potential customer who has not yet performed any transaction with the hospital.

In one embodiment, the review data is retrieved and aggregated from the servers 260 and is categorized into a plurality of categories, for example, as positive, neutral or negative. The categorization may be performed using sentiment analysis. Each of the categories is assigned a respective review score representing a customer rating of the service provider.

At step 140, the service provider rating component 220 computes a rating 270 using the transaction-based measure and the review score. The rating represents a quality of service provided by the hospital. According to a particular example, the rating is simply a weighted sum of the transaction-based measure and the review score. The weights given to the two factors may be dependent on the level of consistency between them. For example, for a review score which contradicts the traffic pattern observed from the transactional level data, the review score will carry little weight when computing the rating.

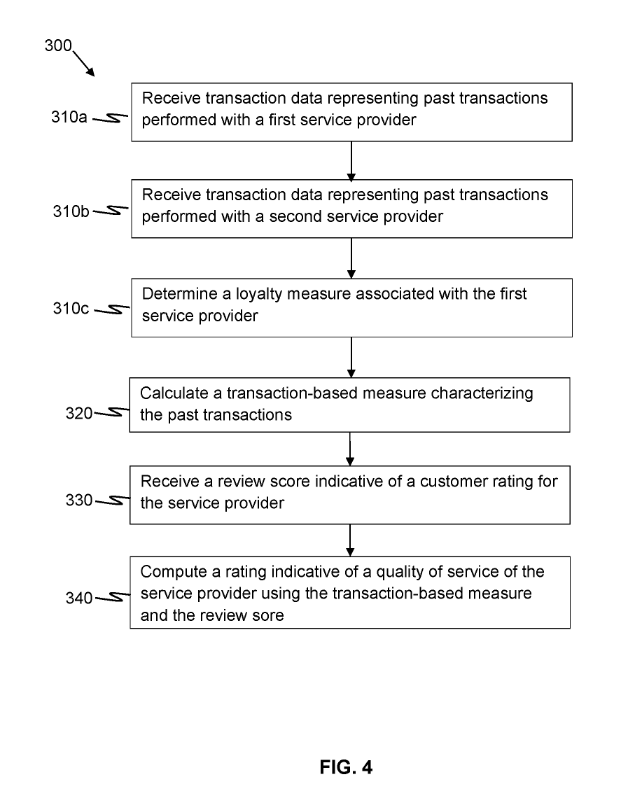

FIG. 4 shows another exemplary method 300 for computing a rating for a service provider according to a further embodiment. The method 300 is different from method 100 in that the method 300 further includes a step 310b of receiving transaction data representing past transactions performed with a second service provider via a payment network and a step of determining a loyalty measure associated with the first service provider. The loyalty measure represents an extent or likelihood of customers continuing using the service rendered by a given service provider, in other words, without the customers switching to an alternative which provides similar service as a substitute for the given service provider. Note that the payment network via which past transactions are performed with the second service provider may or may not be the same as the payment network via which past transactions are performed with the first service provider.

The loyalty measure may be calculated using the transaction data associated with the first and second service providers. For example, the transaction analysis component 310 identifies one or more payment devices which have had performed transactions with both hospitals within a certain timespan, such as 1 month. For another example, the timespan may be 2 weeks, 3 months or 6 months, or any other duration. For example, if the transaction analysis component 310 identifies a payment device which performed one or more transactions with a second hospital at a time within 1 month after a transaction (or the last transaction) performed by the same payment device with a first hospital, this means that it is likely that a patient prefers the second hospital over the first hospital and has made a switch from the first to the second. This will have a negative impact on the loyalty measure of the first service provider. On the other hand, if the transaction analysis component 310 identifies, from the transactions patterns with the first and second hospitals, that a patient has made a switch from the second to the first hospital, the determined loyalty measure for the first service provider will be more favourable, for example, resulting in a higher numerical value.

The transaction analysis component 210 may further include a service provider analysis sub-component for receiving a similarity measure describing an extent of similarity in one or more characteristics of the two service providers (e.g. the two hospitals/clinics), such as a similarity in a geographic location of the service provider and/or an area of specialty in service. For examples, the area of specialty in medicine of two hospitals. The similarity may be used for determining the loyalty measure associated with the service provider. For example, if the two service providers are determined to be providing services in the same specialty and in the same neighbourhood, then it is more likely that the “switch” by the customer is attributable mainly to the dissatisfaction with regards to the quality of the service provider. This may help reduce the contribution of confounding reasons for the switch, for example, if the patient starts transacting with the second service provider for a specialty in their service which is different from that of the first service provider.

At step 320, the transaction-based measure is calculated further using the loyalty measure. Typically, a more favourable loyalty measure will give rise to a more favourable transaction-based measure.

For example, in case of patients recovered well soon after visiting the first hospital and did not perform transactions in other hospital having similar medical specialties during a particular period (i.e. he did not seek a second opinion) then the transaction-based measure for the first hospital is likely to be favourable. The table 1 below illustrates how different transactions patterns may affect on the transaction-based measures for a given hospital.

TABLE 1
Different transaction patterns Vs. Transaction-based measures

| The Number of | Any transactions performed | Transaction- |
|---|---|---|
| Transactions | with other hospital | based measures |
| with a given | having the same or similar | (e.g. on a |
| hospital | specialty in medicine | scale of 10) |
| High | No | 10 |
| High | Yes | 8 |
| Medium | No | 8 |
| Medium | Yes | 6 |
| Low | No | 6 |
| Low | Yes | 4 |

The method may include further steps of calculating a rating for each of a plurality of service providers and delivering the results containing ratings for all or a part of the service providers to the users, for example, by a web interface or a software application. The method may also include generating recommendations materials including a sub-set of the service providers based on the ratings of the service providers. The method may generate recommendation material further using a locality of the service provider. In other words, a potential customer may receive recommendations of a best service provider of a service category within a pre-defined geographic proximity.

Whilst the foregoing description has described exemplary embodiments, it will be understood by those skilled in the art that many variations of the embodiment can be made within the scope and spirit of the present invention. For example, ratings may be for individual departments of a hospital, by identifying from past transactions performed by patients with the doctors/departments within the hospital. Such transactions may be identified from, for example, transaction data or record containing one or more designated merchant terminal identifiers which are associated with transactions carried out with the particular departments of the hospital, or from other information fields of the transaction record, including manually entered data.

1. A computer-implemented method for computing a rating for a service provider, the method comprising operations of:
(a) receiving, by a transaction analysis component, transaction data representing past transactions performed by customers with the service provider via a payment network,
(b) calculating, by the transaction analysis component, a transaction-based measure characterizing the past transactions during a pre-defined period;
(c) receiving, by a service provider rating component, a review score indicative of a customer rating for the service provider; and
(d) computing, by the service provider rating component, the rating using the transaction-based measure and the review score, said rating being indicative of a quality of service associated with the service provider.

2. A method according to claim 1, wherein the transaction-based measure represents a number of the past transactions during the pre-defined period.

3. A method according to claim 1, said transaction data comprising information about payment devices associated with respective past transactions.

4. A method according to claim 3, wherein the method comprises:
the transaction analysis component determining, for each payment device, a number of all the past transactions associated with the payment device within the pre-defined period,
the transaction analysis component identifying one or more payment devices which are being associated with more than one past transactions; and
the service provider rating component calculating the transaction-based measure using the one or more identified payment devices.

5. A method according to claim 4, wherein the transaction analysis component generating, for each payment device, a weight factor based on the number of all the past transactions associated with the payment device; wherein the service provider rating component calculates the transaction-based measure using at least one of (i) the number and (ii) the corresponding weight factor, associated with each of the payment devices.

6. A method according to claim 5, wherein the weight factor for the payment device increases as the number increases.

7. A method according to claim 4, wherein the transaction-based measure represents a ratio of a number of the past transactions performed by the identified payment devices to a total number of the past transactions.

8. A method according to claim 4, wherein the transaction-based measure represents a ratio of a number of the identified payment devices to a total number of the payment devices.

9. A method according to claim 1, wherein operation (d) comprises calculating a weighted sum of the transaction-based measure and the review score.

10. A method according to claim 3, further comprising:
the transaction analysis component receiving further transaction data representing past transactions performed by customer with a second service provider via a payment network, said further transaction data including information about payment devices associated with respective past transactions, the second service provider being a substitute to the service provider in respect of a range of services provided, the method further comprising:
identifying one or more payment devices which performed transactions with both service providers within a pre-defined time window;
determining a loyalty measure associated with the service provider using the identified transactions; and
calculating the transaction-based measure further using the loyalty measure.

11. A method according to claim 10 further comprising
receiving, by a service provider analysis component, a similarity measure describing an extent of similarity in one or more characteristics of the two service providers, said characteristics comprising one or more of: (i) a geographic location of the service provider and (ii) an area of specialty in service; and
determining, by the service provider analysis component, the loyalty measure associated with the service provider further using the similarity measure.

12. A method according to claim 11, wherein the two service providers are healthcare service providers and said characteristics comprises an area of specialty in medicine of the healthcare service provider.

13. A method according to claim 1, wherein the review data is received from one or more social media servers.

14. A system for computing a rating for a service provider, said system comprising:
a computer processor and a data storage device, the data storage device storing non-transitory instructions operative by the processor to cause the processor to perform the operations of:
(a) receiving transaction data representing past transactions performed by customers with the service provider via a payment network,
(b) calculating a transaction-based measure characterizing the past transactions during a pre-defined period;
(c) receiving a review score indicative of a customer rating for the service provider; and
(d) computing the rating using the transaction-based measure and the review score, said rating being indicative of a quality of service associated with the service provider.

15. A system according to claim 14, wherein the transaction-based measure represents a number of the past transactions during the pre-defined period.

16. A system according to claim 14, said transaction data comprising information about payment devices associated with respective past transactions.

17. A system according to claim 16, wherein the data storage device further stores non-transitory instructions operative by the processor to cause the processor to:
determine, for each payment device, a number of all the past transactions associated with the payment device within the pre-defined period,
identify one or more payment devices which are being associated with more than one past transactions; and
calculate the transaction-based measure using the one or more identified payment devices.

18. A system according to claim 17, wherein the data storage device storing non-transitory instructions operative by the processor to cause the processor to:
generate, for each payment device, a weight factor based on the number of all the past transactions associated with the payment device; and
calculate the transaction-based measure using at least one of (i) the number and (ii) the corresponding weight factor, associated with each of the payment devices.

19. A system according to claim 18, wherein the weight factor for the payment device increases as the number increases.

20. A system according to claim 17, wherein the transaction-based measure represents a ratio of a number of the past transactions performed by the identified payment devices to a total number of the past transactions.

21. A system according to claim 17, wherein the transaction-based measure represents a ratio of a number of the identified payment devices to a total number of the payment devices.

22. A system according to claim 14, wherein the data storage device further stores non-transitory instructions operative by the processor to cause the processor to compute the rating by calculating a weighted sum of the transaction-based measure and the review score.

23. A system according to claim 16, wherein the data storage device further stores non-transitory instructions operative by the processor to cause the processor to:
receive further transaction data representing past transactions performed by customer with a second service provider via a payment network, said further transaction data including information about payment devices associated with respective past transactions, the second service provider being a substitute to the service provider in respect of a range of services provided,
identify one or more payment devices which performed transactions with both service providers within a pre-defined time window;
determine a loyalty measure associated with the service provider using the identified transactions; and
calculate the transaction-based measure further using the loyalty measure.

24. A system according to claim 23, wherein the data storage device further stores non-transitory instructions operative by the processor to cause the processor to:
receive a similarity measure describing an extent of similarity in one or more characteristics of the two service providers, said characteristics comprising one or more of: (i) a geographic location of the service provider and (ii) an area of specialty in service; and
determine the loyalty measure associated with the service provider further using the similarity measure.

25. A system according to claim 24, wherein the two service providers are healthcare service providers and said characteristics comprises an area of specialty in medicine of the healthcare service provider.

26. A system according to claim 14, wherein the review data is received from one or more social media servers.

27. A non-transitory computer-readable medium for computing a rating for a service provider, the computer-readable medium having stored thereon program instructions for causing at least one processor to perform operations of:
(a) receiving transaction data representing past transactions performed by customers with the service provider via a payment network,
(b) calculating a transaction-based measure characterizing the past transactions during a pre-defined period;
(c) receiving a review score indicative of a customer rating for the service provider; and
(d) computing the rating using the transaction-based measure and the review score, said rating being indicative of a quality of service associated with the service provider.

28. A non-transitory computer-readable medium according to claim 27, wherein the transaction-based measure represents a number of the past transactions during the pre-defined period.

29. A non-transitory computer-readable medium according to claim 27, said transaction data comprising information about payment devices associated with respective past transactions.

30. A non-transitory computer-readable medium according to claim 29 further storing non-transitory instructions operative by the processor to cause the processor to:
determine, for each payment device, a number of all the past transactions associated with the payment device within the pre-defined period,
identify one or more payment devices which are being associated with more than one past transactions; and
calculate the transaction-based measure using the one or more identified payment devices.

31. A non-transitory computer-readable medium according to claim 30 further storing non-transitory instructions operative by the processor to cause the processor to:
generate, for each payment device, a weight factor based on the number of all the past transactions associated with the payment device; and
calculate the transaction-based measure using at least one of (i) the number and (ii) the corresponding weight factor, associated with each of the payment devices.

32. A non-transitory computer-readable medium according to claim 31, wherein the weight factor for the payment device increases as the number increases.

33. A non-transitory computer-readable medium according to claim 30, wherein the transaction-based measure represents a ratio of a number of the past transactions performed by the identified payment devices to a total number of the past transactions.

34. A non-transitory computer-readable medium according to claim 30, wherein the transaction-based measure represents a ratio of a number of the identified payment devices to a total number of the payment devices.

35. A non-transitory computer-readable medium according to claim 27 further storing non-transitory instructions operative by the processor to cause the processor to compute the rating by calculating a weighted sum of the transaction-based measure and the review score.

36. A non-transitory computer-readable medium according to claim 29 further storing non-transitory instructions operative by the processor to cause the processor to:
receive further transaction data representing past transactions performed by customer with a second service provider via a payment network, said further transaction data including information about payment devices associated with respective past transactions, the second service provider being a substitute to the service provider in respect of a range of services provided,
identify one or more payment devices which performed transactions with both service providers within a pre-defined time window;
determine a loyalty measure associated with the service provider using the identified transactions; and
calculate the transaction-based measure further using the loyalty measure.

37. A non-transitory computer-readable medium according to claim 36 further storing non-transitory instructions operative by the processor to cause the processor to:
receive a similarity measure describing an extent of similarity in one or more characteristics of the two service providers, said characteristics comprising one or more of: (i) a geographic location of the service provider and (ii) an area of specialty in service; and
determine the loyalty measure associated with the service provider further using the similarity measure.

38. A non-transitory computer-readable medium according to claim 37, wherein the two service providers are healthcare service providers and said characteristics comprises an area of specialty in medicine of the healthcare service provider.

39. A non-transitory computer-readable medium according to claim 27, wherein the review data is received from one or more social media servers.
